(19) United States
(12) Patent Application Publication
(10) Pub. No.: US 2012/0285487 A1
(43) Pub. Date: Nov. 15, 2012

(54) DUST ELIMINATION ATTACHMENT DEVICE AND METHOD OF USE

(76) Inventor: Donald Richard Courson, Portland, OR (US)

(21) Appl. No.: 13/107,925

(22) Filed: May 15, 2011

(51) Int. Cl. B08B 5/04; A47L 9/00

(52) U.S. Cl. 134/21; 15/415.1

(57) ABSTRACT

The present invention is a dust elimination attachment device used in combination with a container and a vacuum hose that includes a two pronged tubular body with a top and a bottom with two sides, a securing loop disposed on the top of the tubular body to receive and secure the vacuum hose and a pair of open ended prongs to receive an edge of the container disposed on the bottom of tubular body. The prongs are utilized to receive an edge of the container to secure the device and the vacuum hose to the container. There is also a method for using a dust elimination attachment device in combination with a container and a vacuum hose.

This application incorporates by reference U.S. Provisional Application 61/266,178 filed on Dec. 3, 2009.

### TECHNICAL FIELD & BACKGROUND

The present invention generally relates to a dust elimination attachment device. More specifically, the invention is a dust elimination attachment device that can be utilized in combination with a vacuum hose and a container without a user having to wear the device.

It is an object of the invention to provide a dust elimination attachment device that is utilized to removably attach a vacuum hose to a container that is receiving substances that produce dust when added into the container.

It is an object of the invention to provide a dust elimination attachment device that can be utilized without a user having to wear the device that eliminates a person from inhaling dust from a dust producing substance when being mixed.

It is an object of the invention to provide a dust elimination attachment device that can be utilized without a user having to wear the device that prevents contamination of a work area from a dust producing substance when being mixed.

What is really needed is a dust elimination attachment device that is utilized to removably attach a vacuum hose to a container that is receiving substances that produce dust when poured into the container that can be utilized without a user having to wear the device that eliminates a person from inhaling dust from a dust producing substance when being added and prevents contamination of a work area from a dust producing substance when being mixed without a user having to wear the dust elimination attachment device.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates an environmental side perspective view of a dust elimination attachment device, in accordance with one embodiment of the present invention.

FIG. 1B illustrates a front perspective view of a dust elimination attachment device, in accordance with one embodiment of the present invention.

FIG. 1C illustrates a side perspective view of a dust elimination attachment device, in accordance with one embodiment of the present invention.

FIG. 2 illustrates a flowchart of the steps of a method for using a dust elimination attachment device, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

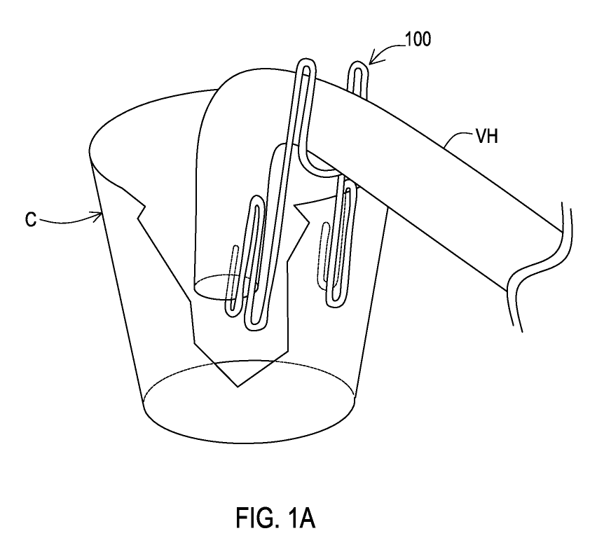

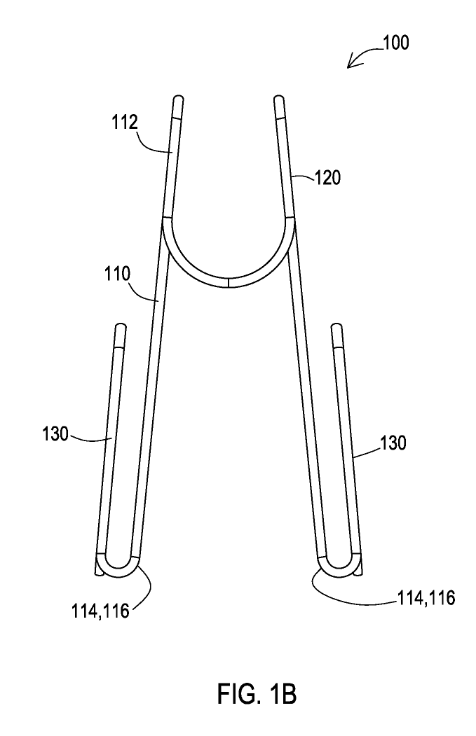

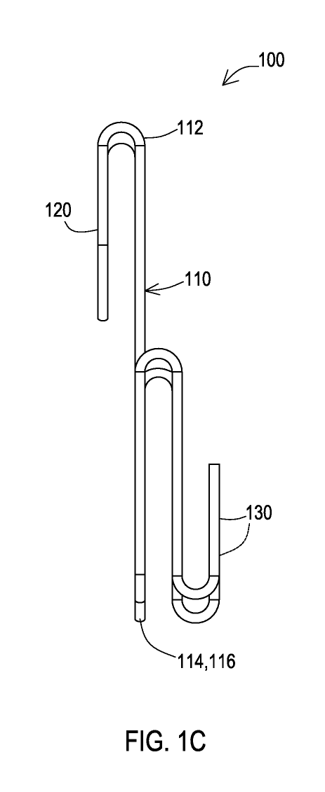

FIG. 1A illustrates an environmental side perspective view of a dust elimination attachment device 100, in accordance with one embodiment of the present invention. The dust elimination attachment device 100 is utilized in combination with a vacuum hose VH and a container C. The dust elimination attachment device 100 removably attaches the vacuum hose VH to the edge of a container C so that the vacuum hose VH can vacuum dust that is created when dust from a dust producing substance is added to a container C. Typically these dust producing substances are powdered, granular or solids that form dust, although any suitable dust producing substance and its dust can be eliminated with the dust elimination attachment device 100.

FIG. 1B illustrates a front perspective view of a dust elimination attachment device 100, in accordance with one embodiment of the present invention. The dust elimination attachment device 100 includes a two pronged tubular body 110 with a top 112 and a bottom 114 with two sides 116, a securing loop 120 disposed on top 112 and an open ended prong 130 disposed on the bottom of each side 116 of the two pronged tubular body 110.

FIG. 1C illustrates a side perspective view of a dust elimination attachment device 100, in accordance with one embodiment of the present invention. The securing loop 120 is utilized to receive and secure a vacuum hose VH that will vacuum any dust produced by the dust producing substances added to the container C. The open ended prongs 130 are utilized to receive an edge of a container C to secure the dust elimination device 100 and a received and secured vacuum hose VH to the container C. The container C can be any container with an edge that the dust elimination attachment device 100 can be inserted onto utilizing the open ended prongs 130 such as a bucket and can be any suitable container with a usable edge to receive the open ended prongs 130.

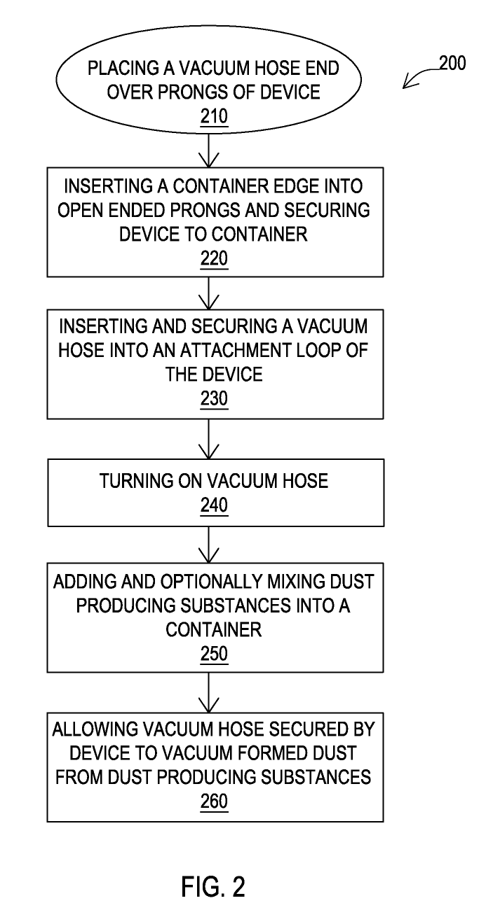

FIG. 2 illustrates a flowchart of the steps of a method for using a dust elimination attachment device 200, in accordance with one embodiment of the present invention. The steps of the overall method 200 include placing an end of a vacuum hose over open ended prongs of device 210, inserting an edge of a container into open ended prongs and securing device to container 220, inserting and securing a vacuum hose into an attachment loop of the device 230, turning-on said vacuum hose 240 and adding and optionally mixing dust producing substances into a container 250 and allowing the vacuum hose secured by device to vacuum formed dust from dust producing substances 260.

As previously described in FIGS. 1A, 1B and 1C and their descriptions, the dust producing substances typically are powdered, granular or solids that form dust, although any suitable dust producing substance and its dust can be eliminated with the dust elimination attachment device. The overall method for using 200 is designed to be used in combination with a vacuum hose and container. The container can be any container with an edge that the device can be inserted onto utilizing the two prongs to secure the device and vacuum hose such as a bucket and can be any suitable container with a usable edge.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A dust elimination attachment device used in combination with a container and a vacuum hose, comprising:
a tubular body with a top and a bottom with two sides;
a securing loop disposed on said top of tubular body to receive and secure said vacuum hose; and
a plurality of open ended prongs to receive said container disposed on said bottom of tubular body.

2. The device according to claim 1, wherein said tubular body is a two pronged tubular body.

3. The device according to claim 1, wherein there are two said open ended prongs.

4. The device according to claim 3, wherein said prongs are utilized to receive said container to secure said device and said vacuum hose to said container.

5. The device according to claim 4, wherein said container has a usable edge to receive said prongs,

6. The device according to claim 1, wherein said container is a bucket.

7. The device according to claim 1, wherein said vacuum hose vacuums any dust formed from any dust producing substances added to said container.

8. A dust elimination attachment device used in combination with a container and a vacuum hose, comprising:
a two pronged tubular body with a top and a bottom with two sides;
a securing loop disposed on said top of tubular body to receive and secure said vacuum hose; and
a pair of open ended prongs to receive an edge of said container disposed on said bottom of tubular body.

9. The device according to claim 8, wherein said prongs are utilized to receive said container to secure said device and said vacuum hose to said container.

10. The device according to claim 9, wherein said container has a usable edge to receive said prongs.

11. The device according to claim 10, wherein said container is a bucket.

12. The device according to claim 8, wherein said vacuum hose vacuums any dust formed from any dust producing substances added to said container.

13. A method for using a dust elimination attachment device in combination with a container and a vacuum hose, comprising the steps of:
placing an end of said vacuum hose over open ended prongs of said device;
inserting an edge of said container into said open ended prongs and securing said device to said container;
inserting and securing said vacuum hose into an attachment loop of said device;
turning-on said vacuum hose and adding and optionally mixing dust producing substances into said container; and
allowing said vacuum hose secured by said device to vacuum formed dust from said dust producing substances.

14. The method according to claim 13, wherein said device has a tubular body with a top and a bottom with two sides.

15. The method according to claim 14, wherein said tubular body is a two pronged tubular body.

16. The method according to claim 15, wherein said attachment loop is disposed on said top of said body.

17. The method according to claim 15, wherein said prongs are disposed on said bottom with sides.

18. The method according to claim 17, wherein there are two said open ended prongs.

19. The method according to claim 13, wherein said container has a usable edge to receive said prongs.

20. The method according to claim 13, wherein said container is a bucket.
